(19) United States
(12) Patent Application Publication
(10) Pub. No.: US 2016/0216692 A1
(43) Pub. Date: Jul. 28, 2016

(54) TABLE-TOP TYPE HOLOGRAM PROJECTION APPARATUS USING ASPHERIC MIRROR

(71) Applicant: Electronics and Telecommunications Research Institute, Daejeon (KR)

(72) Inventors: Hyun Eui KIM, Cheongju-si (KR); Min Sik PARK, Sejong (KR); Jae Han KIM, Gwacheon-si (KR); Jin Woong KIM, Daejeon (KR); Kyung Ae MOON, Daejeon (KR)

(73) Assignee: Electronics and Telecommunications Research Institute, Daejeon (KR)

(21) Appl. No.: 15/003,070

(22) Filed: Jan. 21, 2016

(30) Foreign Application Priority Data
Jan. 28, 2015 (KR) 10-2015-0013444

(51) Int. Cl. G03H 1/22; G03H 1/30; G02B 26/08

(52) U.S. Cl. CPC G03H 1/2205; G03H 1/2294; G02B 26/0816; G03H 1/30; G02B 26/0833; G03H 2001/2239; G03H 2001/2297; G03H 2001/221; G03H 2001/2242

(57) ABSTRACT

Provided is a hologram projection apparatus using an aspheric mirror, the apparatus including a spatial light modulator (SLM), a first mirror, a motor, and a second mirror, wherein the first mirror is configured to reflect modulated light output by the SLM, the motor is configured to rotate the first mirror, the second mirror is configured to reflect the modulated light reflected from the rotated first mirror, and the modulated light reflected from the second mirror, based on a degree of rotation of the first mirror, forms a consecutive viewing window in a horizontal direction.

This application claims the priority benefit of Korean Patent Application No. 10-2015-0013444, filed on Jan. 28, 2015, in the Korean Intellectual Property Office, the disclosure of which is incorporated herein by reference.

### BACKGROUND

1. Field of the Invention

Embodiments relate to a table-top type hologram display apparatus for forming a viewing window for a plurality of users.

2. Description of the Related Art

A table-top type display device is a device for providing a three-dimensional (3D) image to a plurality of users surrounding a display device. Accordingly, the table-top type display device may provide the users surrounding the display device with hologram images displayed to correspond to respective users.

A conventional table-top type display device uses a volumetric display structure that synchronizes a high-speed operating projector with a high-speed rotating screen. However, the high-speed operating projector and the high-speed rotating screen are unable to present phase information associated with the displayed hologram images. Since the conventional table-top type display is unable to provide a monocular depth recognition factor, for example, an accommodation effect of an eye, an accommodation-convergence mismatch may occur. Accordingly, a user may have an issue of sensing an eye fatigue, discomfort, and awkwardness of a displayed image.

Therefore, a device for implementing a hologram display in a large screen through a viewing window which is limited to a pupil size has been requested in a table-top type display device.

### SUMMARY

According to an aspect, there is provided a hologram projection apparatus including a spatial light modulator (SLM), a first mirror, a motor, and a second mirror, wherein the first mirror is configured to reflect modulated light output by the SLM, the motor is configured to rotate the first mirror, the second mirror is configured to reflect the modulated light reflected from the rotated first mirror, and the modulated light reflected from the second mirror, based on a degree of rotation of the first mirror, forms a consecutive viewing window in a horizontal direction.

The motor may be configured to form, on a rotation axis around which the first mirror is rotated, a structure of incidence of the modulated light to the first mirror.

The SLM may be configured to change a hologram image to modulate input light based on a location at which the viewing window is formed.

The motor may be configured to synchronize a rotation speed of the first mirror based on a play speed of the hologram image.

The modulated light reflected from the second mirror may be enlarged in the second mirror and increases a size of a hologram image, and the enlarged modulated light may be condensed to a pupil size of a user and form the viewing window.

The SLM may be configured to control a play time per frame of a hologram image used for modulating an input light, to be less than or equal to a threshold value.

The SLM may be configured to apply off-axis encoding to a hologram image used for modulating input light and move a location of the viewing window to a location at which an order is not generated.

The hologram projection apparatus may further include a noise filter configured to block noise incident to an eye of a user, the noise filter provided at a position of a focal point of a lens that outputs the modulated light by the SLM.

According to another aspect, there is provided a hologram projection apparatus including a plurality of SLMs, a first mirror, and a second mirror, wherein the plurality of SLMs is arranged in a vertical direction, the first mirror is configured to reflect each of modulated lights output by the plurality of SLMs to the second mirror, the second mirror is configured to reflect the modulated lights reflected from the first mirror, and the modulated lights reflected from the second mirror are enlarged based on locations of the plurality of SLMs and form consecutive viewing windows in a vertical direction.

The plurality of SLMs may be configured to modulate input lights using hologram images corresponding to respective locations at which the viewing windows are formed.

The plurality of SLMs may be arranged in a form of an arc centered on the first mirror.

According to still another aspect, there is provided a hologram projection apparatus including a plurality of SLMs, a first mirror, a motor, and a second mirror, wherein the plurality of SLMs is arranged in a vertical direction, the first mirror is configured to reflect each of modulated lights output by the SLMs to the second mirror, the motor is configured to rotate the first mirror, the second mirror is configured to reflect the modulated lights reflected from the rotated first mirror, the modulated lights reflected from the second mirror are enlarged based on locations of the plurality of SLMs and form consecutive viewing windows in a vertical direction, and the consecutive viewing windows in a vertical direction rotate based on a degree of rotation of the first mirror and form consecutive viewing windows in a circular form in a horizontal direction.

The plurality of SLMs may be configured to change, when the plurality of SLMs are digital micro mirror devices (DMDs), directions of the modulated lights to be incident to the first mirror by folding mirrors included in the DMDs.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a hologram projection apparatus according to an embodiment;

FIG. 2 illustrates a first example of a hologram projection apparatus according to an embodiment;

FIG. 3 illustrates a top view and a side cross-sectional view of a hologram projection apparatus according to an embodiment;

FIGS. 4A and 4B illustrate examples of a motor included in a hologram projection apparatus according to an embodiment;

FIG. 5 illustrates a second example of a hologram projection apparatus according to an embodiment; and

FIG. 6 is a third example of a hologram projection apparatus according to an embodiment.

### DETAILED DESCRIPTION

Reference will now be made in detail to embodiments of the present invention, examples of which are illustrated in the accompanying drawings, wherein like reference numerals refer to like elements throughout. Embodiments are described below to explain the present invention by referring to the figures.

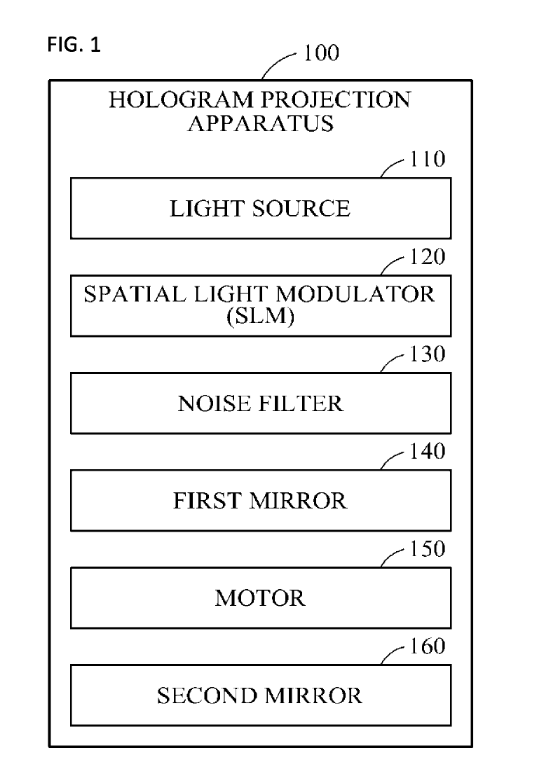

FIG. 1 is a block diagram illustrating a hologram projection apparatus according to an embodiment.

As illustrated in FIG. 1, a hologram projection apparatus 100 includes a light source 110, a spatial light modulator (SLM) 120, a noise filter 130, a first mirror 140, a motor 150, and a second mirror 160. For example, the hologram projection apparatus 100 may be a table-top type three-dimensional (3D) hologram display apparatus.

The light source 110 outputs input light for generating a viewing window. For example, the light source 110 may output input light having a plane wave on which collimation is performed.

Here, the light source 110 may include a shutter to control an output time of light. The shutter may control the input light to be output to the SLM 120 only during an interval less than a threshold value, by performing high-speed shuttering.

The SLM 120 may modulate the input light incident from the light source 110 to a hologram image corresponding to a viewpoint of a user. The SLM 120 may output modulated light according to the hologram image. For example, the hologram image may be a computer generated hologram (CGH). The SLM 120 may be a digital micro mirror device (DMD) to modulate light at high speeds.

The SLM 120 may provide red-green-blue (RGB) of a hologram image in a time division multiplexing (TDM) method by modulating light using hologram images corresponding to each wavelength of red, green, and blue.

Also, a plurality of SLMs, for example, the SLM 120, may be arranged in a vertical direction in the hologram projection apparatus 100. Here, the plurality of SLMs may respectively output modulated lights that form viewing windows at different heights. The plurality of SLMs may change the hologram images for modulating the input light based on locations at which the viewing windows are formed. The plurality of SLMs may modulate the input light using the hologram images corresponding to each of the locations at which the viewing windows are formed. For example, the plurality of SLMs may be vertically arranged in a form of an arc based on a place in which the hologram projection apparatus 100 is provided.

The noise filter 130 blocks noise incident to an eye of a user, the noise filter provided at a position of a focal point of a lens that outputs the modulated light by the SLM 120. For example, the noise filter 130 may be a noise mask.

The noise filter 130 may filter at least one of a diffracted order in high order, a twin image, and DC noise from the modulated light.

The first mirror 140 reflects the modulated light output by the SLM 120 to the second mirror 160. For example, the first mirror 140 may be a plane mirror.

The motor 150 rotates the first mirror 150 and changes a direction of the modulated light reflected to the second mirror 160. The motor 150 forms, on a rotation axis around which the first mirror 140 is rotated, a structure of incidence of the modulate light to the first mirror 140.

The motor 150 synchronizes a rotation speed of the first mirror 140 based on a play speed of the hologram image of the SLM 120. For example, the hologram projection apparatus 100 may synchronize a rotation speed of the first mirror 140 by the motor 150 and a play speed of the hologram image of the SLM 120 using an embedded real-time system and a field programmable gate array (FPGA).

The second mirror 160 may reflect the modulated light reflected from the first mirror 140 rotated by the motor 150 to a user or a preset location. Here, the modulated light reflected from the second mirror 160 may form consecutive viewing windows in a vertical direction based on a degree of rotation of the first mirror 140. The second mirror 160 may be an aspheric mirror disposed inside a hole vertically penetrating at a center, for example, a form of a donut and a cylinder.

Since the viewing windows are consecutively rotated in a horizontal direction, voxels are displayed to be dragged so that blurring is generated. Accordingly, the hologram projection apparatus 100 may prevent the blurring by controlling a play time per frame of the hologram image to be less than or equal to a threshold value using a DMD as the SLM 120. For example, the DMD may control the play time per frame of the hologram image, to be less than or equal to a millisecond (ms).

The DMD used as the SLM 120 may change a direction of the modulated light to be incident to the first mirror 140 by folding mirror included in the DMD, so that the blurring is not generated in the viewing window.

The SLM 120 applies off-axis encoding to the hologram image and moves a location of the viewing window to a location at which an order is not generated. The hologram projection apparatus 100 may apply the off-axis encoding to the hologram image, thereby preventing a high order generated by a pixel structure and an overlay of a DC noise in the viewing window.

When the plurality of SLMs are arranged in the hologram projection apparatus 100 in a vertical direction, the modulated light reflected from the second mirror 160 is enlarged based on locations of the plurality of SLMs and forms consecutive viewing windows in a vertical direction.

The hologram projection apparatus 100 may enlarge the modulated light output by the SLM 120 through an aspheric mirror having a large diameter and display, to a user, a hologram image to a viewing window formed and focused to a pupil of the user. Accordingly, a hologram display having a large screen may be provided through a viewing window limited to a pupil size.

Also, the hologram projection apparatus 100 may extend a horizontal viewing angle by rotating a mirror reflecting the modulated light to the aspheric mirror and forming consecutive viewing windows in a horizontal direction. The hologram projection apparatus 100 may extend a vertical viewing angle by arranging the plurality of SLMs in a vertical direction and forming consecutive viewing windows in a vertical direction. Accordingly, the hologram projection apparatus 100 may decrease spatial bandwidth size of an SLM needed for extending a viewing angle.

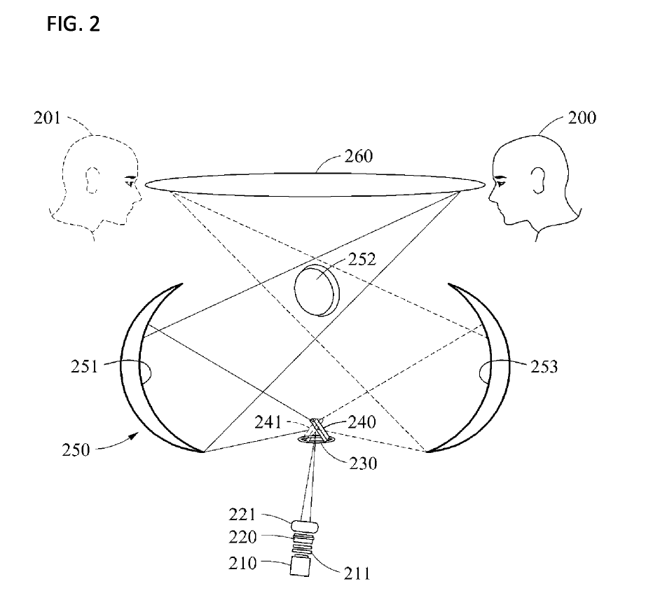

FIG. 2 illustrates a first example of a hologram projection apparatus according to an embodiment.

FIG. 2 illustrates an example of the hologram projection apparatus 100 for providing a consecutive horizontal parallax by generating consecutive viewing windows in a horizontal direction.

As illustrated in FIG. 2, the hologram projection apparatus 100 includes a light source 210, an SLM 220, a motor 230, a first mirror 240, and a second mirror 250.

Input light output from the light source 210 may be incident to the SLM 220 by passing through a polarizer 211.

The SLM 220 may output modulated light by modulating the input light incident from the light source to a hologram image corresponding to a viewpoint of a user. For example, the SLM 220 may be a DMD to modulate light at high speeds.

The modulated light output from a lens 221 of the SLM 220 may be incident to the first mirror 240 by passing through a structure formed on a rotation axis of the motor 230.

The first mirror 240 reflects the incident modulated light to the second mirror 250. Since the first mirror 240 is rotated 360 degrees by the motor 230, a location of the second mirror 250 to which the modulated light reflected from the first mirror 240 is incident may be rotated.

For example, the modulated light reflected from the first mirror 240 may be reflected to a location 251 of the second mirror 250 and represent a hologram image 252. The lens 221 and the second mirror 250 form a 4F system and enlarge the modulated light. The 4F system may be a standard system that transfers an image from a plane to another plane using a pair of lenses.

The modulated light may be condensed by the second mirror 250 and form a viewing window. The modulated light condensed by the second mirror 250 may form a viewing window that displays the hologram image 252 in a pupil of a user located in a location 200 corresponding to the location 251. Conversely, when the first mirror 240 is rotated to a location 241 by the motor 230, the modulated light reflected from the first mirror 240 may be reflected to a location 253 of the second mirror 250 which is different from the location 251 and represent the hologram image 252. The viewing window to display the hologram image 252 is formed in the pupil of the user located in a location 201 corresponding to the location 253.

The motor 230 rotates the first mirror 240 and the hologram projection apparatus 100 may form the viewing window 260 in a circular form. Accordingly, the hologram apparatus 100 may provide a hologram image by forming viewing windows for each location of pupil of a user located on a horizontal circular form.

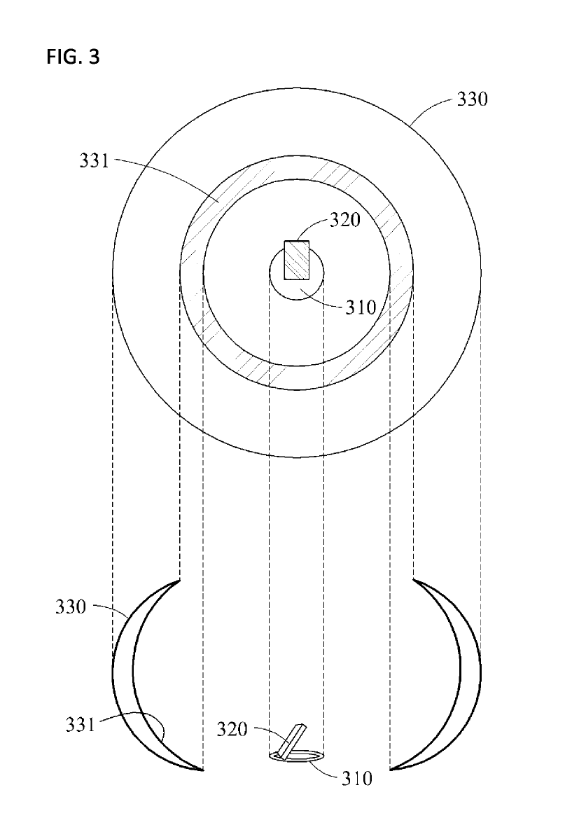

FIG. 3 illustrates a top view and a side cross-sectional view of a hologram projection apparatus according to an embodiment.

As illustrated in FIG. 3, a hole of which a size is greater than a predetermined size may be formed in a center of a second mirror 330 of the hologram projection apparatus 100. In the center of the second mirror 330, a first mirror 320 to reflect modulated light to the second mirror 330 and a motor 310 to rotate the first mirror 320 may be disposed.

A location of reflecting the modulated light from the second mirror 330 may be located on a curved inner side 331, as illustrated in FIGS. 2 and 3.

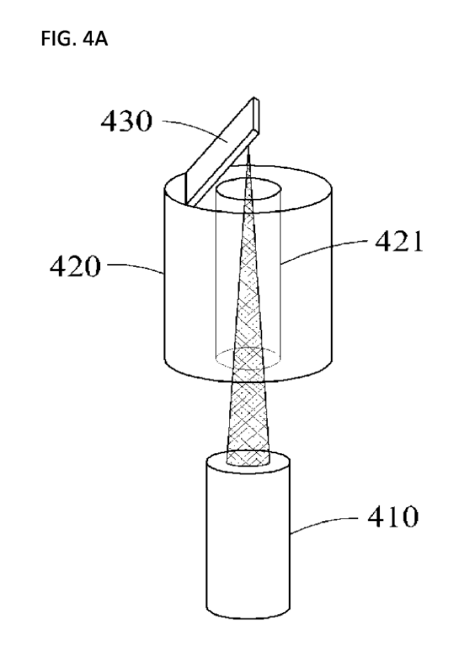

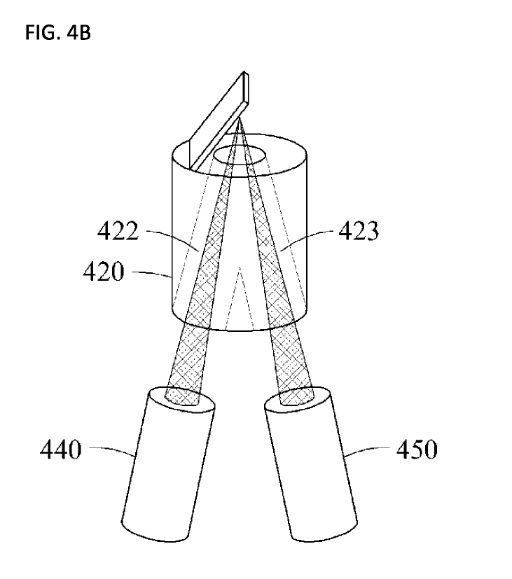

FIGS. 4A and 4B illustrate examples of a motor included in a hologram projection apparatus according to an embodiment.

FIG. 4A illustrates an example of a motor 420 having a rotation axis around which a first mirror 430 is rotated, the rotation axis on which a hole 421 for modulated light output from an SLM 410 to be passed through is formed, when the hologram projection apparatus 100 includes a single SLM 410.

FIG. 4B illustrates an example of the motor 420 having the rotation axis around which the first mirror 430 is rotated, the rotation axis on which a hole 422 for modulated light output from a first SLM 440 to be passed through and a hole 423 for modulated light output by a second SLM 450 to be passed through are formed, when the hologram projection apparatus 100 includes the first SLM 440 and the second SLM 450,

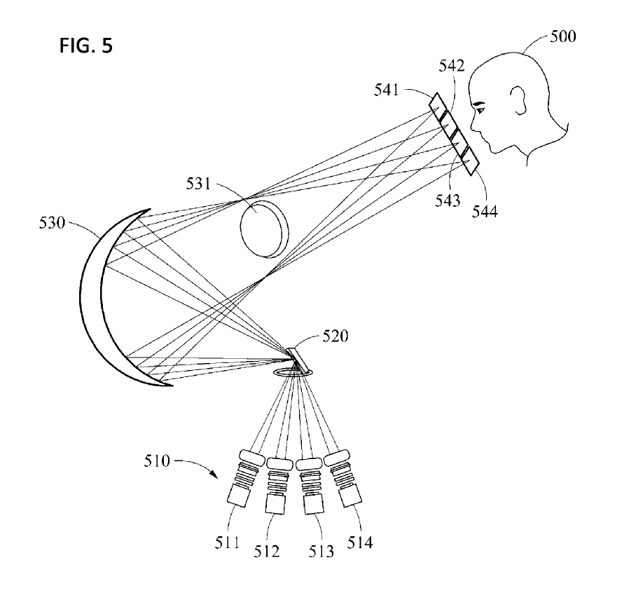

FIG. 5 illustrates a second example of a hologram projection apparatus according to an embodiment.

FIG. 5 illustrates an example of the hologram projection apparatus 100 for providing a consecutive vertical parallax by performing spatial multiplexing and arranging a plurality of SLMs in a vertical direction in a form of an arc centered on a first mirror.

As illustrated in FIG. 5, the hologram projection apparatus 100 includes a first SLM 511, a second SLM 512, a third SLM 513, a fourth SLM 514, a first mirror 520, and a second mirror 530.

Modulated light output from the first SLM 511 may be reflected from the first mirror 520 and incident to the second mirror 530. The modulated light reflected from the second mirror 530 may form a viewing window that represents a hologram image 531 at a location 541.

Modulated light output from the second SLM 512 may be reflected from the first mirror 520 and incident to the second mirror 530. The modulated light reflected from the second mirror 530 may form a viewing window that represents the hologram image 531 at a location 542.

Modulated light output from the third SLM 513 may be reflected from the first mirror 520 and incident to the second mirror 530. The modulated light reflected from the second mirror 530 may form a viewing window that represents the hologram image 531 at a location 543.

Modulated light output from the fourth SLM 514 may be reflected from the first mirror 520 and incident to the second mirror 530. The modulated light reflected from the second mirror 530 may form a viewing window that represents the hologram image 531 at a location 544.

Concisely, the hologram projection apparatus 100 arranges the first SLM 511, the second SLM 512, the third SLM 513, and the fourth SLM 514 in a vertical direction as illustrated in FIG. 5. Accordingly, the viewing windows are formed at the consecutive locations 541, 542, 543, and 544 in the vertical direction. Therefore, even when a location of a pupil of a user 500 is lowered from the location 541 to the location 544, the user 500 is able to view the hologram image 531 through the viewing window formed at the location 544.

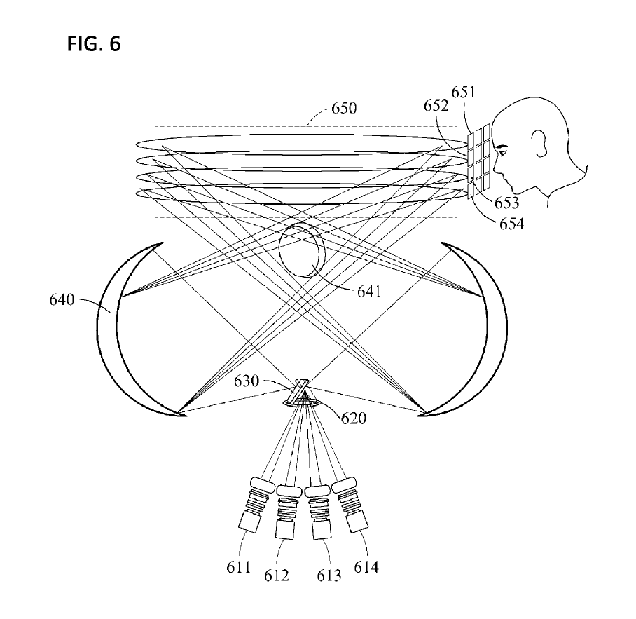

FIG. 6 is a third example of a hologram projection apparatus according to an embodiment.

FIG. 6 illustrates an example of the hologram projection apparatus 100 for providing a consecutive vertical parallax and horizontal parallax using a plurality of SLMs and a motor.

As illustrated in FIG. 6, the hologram projection apparatus 100 includes a first SLM 611, a second SLM 612, a third SLM 613, a fourth SLM 614, a motor 620, a first mirror 630, and a second mirror 640.

Modulated light output from the first SLM 611 may pass through a structure formed on a rotation axis of the motor 620 and incident to the first mirror 630. The first mirror 630 may reflect the incident modulated light to the second mirror 640. The modulated light reflected from the second mirror 640 may form a viewing window that represents a hologram image 641 at a location 651.

Since the first mirror 630 is rotated 360 degrees by the motor 620, a location of the modulated light reflected from the first mirror 630 to be incident to the second mirror 640 may be rotated. Accordingly, the modulated light output from the first SLM 611 may form a viewing window 650 in a circular form, at a height identical to the location 651.

Modulated light output from the second SLM 612 may be reflected from the first mirror 630 and incident to the second mirror 640. The modulated light reflected from the second mirror 640 may form a viewing window that represents the hologram image 641 at a location 652.

Since the first mirror 630 is rotated 360 degrees by the motor 620, a location of the modulated light reflected from the first mirror 630 to be incident to the second mirror 640 may be rotated. Accordingly, the modulated light output from the second SLM 612 may form the viewing window 650 in a circular form, at a height identical to the location 652.

Modulated light output from the third SLM 613 may be reflected from the first mirror 630 and incident to the second mirror 640. The modulated light reflected from the second mirror 640 may form a viewing window that represents the hologram image 641 at a location 653.

Since the first mirror 630 is rotated 360 degrees by the motor 620, a location of the modulated light reflected from the first mirror 630 to be incident to the second mirror 640 may be rotated. Accordingly, the modulated light output from the third SLM 613 may form the viewing window 650 in a circular form, at a height identical to the location 653.

Modulated light output from the fourth SLM 614 may be reflected from the first mirror 630 and incident to the second mirror 640. The modulated light reflected from the second mirror 640 may form a viewing window that represents the hologram image 641 at a location 654.

Since the first mirror 630 is rotated 360 degrees by the motor 620, a location of the modulated light reflected from the first mirror 630 to be incident to the second mirror 640 may be rotated. Accordingly, the modulated light output from the fourth SLM 614 may form the viewing window 650 in a circular form, at a height identical to the location 654.

The hologram projection apparatus 100 may be rotated in 360 degrees using the motor 620 and reflect the light output from the plurality of SLMs 611, 612, 613, and 614 to the second mirror 640 which is an aspheric mirror. Therefore, the hologram projection apparatus 100 may form viewing windows at various heights and horizontal locations, as illustrated in FIG. 6.

According to an aspect of the present invention, it is possible to enlarge a modulated light output to an SLM through an aspheric mirror having a large diameter and display, to a user, a hologram image to a viewing window formed and focused to a pupil of the user. Accordingly, a hologram display having a large screen may be provided through a viewing window limited to a pupil size.

Also, it is possible to extend a horizontal viewing angle by rotating a mirror reflecting the modulated light to the aspheric mirror and forming consecutive viewing windows in a horizontal direction. The hologram projection apparatus 100 may extend a vertical viewing angle by arranging the plurality of SLMs in a vertical direction and forming consecutive viewing windows in a vertical direction. Accordingly, it is possible to decrease an SLM spatial bandwidth size needed for extending a viewing angle.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A hologram projection apparatus comprising:
a spatial light modulator (SLM), a first mirror, a motor, and a second mirror,
wherein the first mirror is configured to reflect modulated light output by the SLM, the motor is configured to rotate the first mirror, the second mirror is configured to reflect the modulated light reflected from the rotated first mirror, and
the modulated light reflected from the second mirror, based on a degree of rotation of the first mirror, forms a consecutive viewing window in a horizontal direction.

2. The apparatus of claim 1, wherein the motor is configured to form, on a rotation axis around which the first mirror is rotated, a structure of incidence of the modulated light to the first mirror.

3. The apparatus of claim 1, wherein the SLM is configured to change a hologram image to modulate input light based on a location at which the viewing window is formed.

4. The apparatus of claim 3, wherein the motor is configured to synchronize a rotation speed of the first mirror based on a play speed of the hologram image.

5. The apparatus of claim 1, wherein the modulated light reflected from the second mirror is enlarged in the second mirror and increases a size of a hologram image, and the enlarged modulated light is condensed to a pupil size of a user and form the viewing window.

6. The apparatus of claim 1, wherein the SLM is configured to control a play time per frame of a hologram image used for modulating input light, to be less than or equal to a threshold value.

7. The apparatus of claim 1, wherein the SLM is configured to apply off-axis encoding to a hologram image used for modulating input light and move a location of the viewing window to a location at which an order is not generated.

8. The apparatus of claim 1, further comprising:
a noise filter configured to block noise incident to an eye of a user, the noise filter provided at a position of a focal point of a lens that outputs the modulated light by the SLM.

9. A hologram projection apparatus comprising:
a plurality of spatial light modulators (SLMs), a first mirror, and a second mirror,
wherein the plurality of SLMs is arranged in a vertical direction, the first mirror is configured to reflect each of modulated lights output by the plurality of SLMs to the second mirror, the second mirror is configured to reflect the modulated lights reflected from the first mirror, and
the modulated lights reflected from the second mirror are enlarged based on locations of the plurality of SLMs and form consecutive viewing windows in a vertical direction.

10. The apparatus of claim 9, wherein the plurality of SLMs is configured to modulate input lights using hologram images corresponding to respective locations at which the viewing windows are formed.

11. The apparatus of claim 9, wherein the plurality of SLMs is arranged in a form of an arc centered on the first mirror.

12. The apparatus of claim 9, wherein the plurality of SLMs are configured to apply off-axis encoding to a hologram image used for modulating input light and move a location of a viewing window to a location at which an order is not generated.

13. The apparatus of claim 12, further comprising:
a noise filter configured to block noise incident to an eye of a user, the noise filter provided at a position of a focal point of a lens that outputs the modulated lights by the plurality of SLMs.

14. A hologram projection apparatus comprising:
a plurality of spatial light modulators (SLMs), a first mirror, a motor, and a second mirror,
wherein the plurality of SLMs is arranged in a vertical direction, the first mirror is configured to reflect each of modulated lights output by the SLMs to the second mirror,
the motor is configured to rotate the first mirror, the second mirror is configured to reflect the modulated lights reflected from the rotated first mirror,
the modulated lights reflected from the second mirror are enlarged based on locations of the plurality of SLMs and form consecutive viewing windows in a vertical direction, and the consecutive viewing windows in a vertical direction are rotated based on a degree of rotation of the first mirror and form consecutive viewing windows in a circular form in a horizontal direction.

15. The apparatus of claim 14, wherein the motor is configured to form, on a rotation axis around which the first mirror is rotated, a structure of incidence of each of the modulated lights output by the plurality of SLMs, to the first mirror.

16. The apparatus of claim 14, wherein the plurality of SLMs is configured to change a hologram image to modulate input light based on locations at which the viewing windows are formed.

17. The apparatus of claim 14, wherein the motor is configured to synchronize a rotation speed of the first mirror based on a play speed of the hologram image.

18. The apparatus of claim 14, wherein the plurality of SLMs is arranged in a form of an arc centered on the first mirror.

19. The apparatus of claim 14, wherein the plurality of SLMs is configured to control a play time per frame of a hologram image used for modulating input light, to be less than or equal to a threshold value.

20. The apparatus of claim 19, wherein the plurality of SLMs is configured to change, when the plurality of SLMs are digital micro mirror devices (DMDs), directions of the modulated lights to be incident to the first mirror by folding mirrors comprised in the DMDs.
